(19) United States
(12) Patent Application Publication
(10) Pub. No.: US 2010/0193541 A1
(43) Pub. Date: Aug. 5, 2010

(54) DISPENSER OF CLEAN DRINK CUP CLOSURES AND CONDIMENTS

(76) Inventors: Harvey James Tester, Elizabethton, TN (US); Lynn Ward Salts, Johnson City, TN (US)

Correspondence Address: Kenneth Bower, 314 Ironstone Lane, Elverson, PA, 19520, US

(21) Appl. No.: 12/650,328

(22) Filed: Dec. 30, 2009

Related U.S. Application Data
(60) Provisional application No. 61/149,412, filed on Feb. 3, 2009.

(51) Int. Cl. B65D 83/00; A47F 1/08; B08B 9/00

(52) U.S. Cl. 221/97; 221/281; 221/155; 134/22.1

(57) ABSTRACT

Disclosed is a dispenser for items such as disposable cup closures that maintains a high degree of protection from air borne disease, contamination from adjoining surfaces or from contact with the hands of other patrons. The wide acceptance of clean technology depends on uncompromised convenience, productivity and cost as well as satisfying other needs of the store or restaurant proprietors including both dispenser appearance and low use of counter space. The present invention therefore provides clean dispensing of items like cup closures and packaged condiments in a device that is easy to maintain, clean and keep filled, mounts anywhere in a small space is aesthetically pleasing and can be customized to match any décor. Disclosed is a unique combination of a number of small details that together can play a crucial role in protecting the patrons from the spread of a pandemic.

### CROSS-REFERENCE TO RELATED APPLICATIONS

This application claims priority of the Provisional Application for Patent 61/149,412, having the same inventive entity and dated Feb. 2, 2009, under 37 CFR 1.53(c).

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

The present invention is in the field of dispensing covers for disposable food and drink containers or any similar thin flexible stackable items.

### BACKGROUND OF THE INVENTION

The present invention represents a significant step forward in the field of dispensing covers for disposable food and drink containers. Dispensing devices are known for containing a stack of items such as disposable cup closures that make the top or bottom item available to remove from the stack. Typically, these dispensing devices are difficult to keep clean and do little to protect the items from air borne disease or from contact with disease transferred from the hands of other patrons. Inadvertently dispensed multiple items are often laid on the contaminated counters and subsequently returned to the dispenser by well meaning patrons and restaurant employees. Further there is a need for the clean handling of individual packets of condiments.

However, there are a number of small details that together can play a crucial role in protecting the patrons from the spread of a pandemic that are addressed by the instant invention. The wide acceptance of clean technology depends on satisfying other needs of the store or restaurant proprietors including both dispenser appearance and shortage of counter space. The present invention therefore addresses the problems of clean dispensing of cup closures and packaged condiments. Additional attributes are incorporated to justify replacement of existing equipment such as ease of cleaning and refilling, mounting anywhere, small footprint and customization to match the décor of its surroundings.

The preferred embodiment of the present invention is shown in FIGS. 1-4. The primary features of the present invention are to make an economically manufactured dispenser for items such as disposable cup closures that keeps the closures clean, is easy for patrons to use and for the proprietor to keep the chutes full and clean.

### DESCRIPTION OF RELATED ART

Prior art shows a patent to Steele (U.S. Pat. No. 4,643,334 expired) that discloses a stack of disposable cup closures contained in a dispenser that provides access to the closures in the stack. The stack of cup closures is contained in cylinders 22, 24, 26 and 28 with a completely open slit 36 of FIG. 3 that allows restaurant employees to monitor the inventory of closures. However, an open slit cylinder construction is notorious for manufacturing problems whether formed of ductile material or molded or extruded of non-ductile materials, because of material spring back that varies depending on the source of raw materials often requiring secondary operations to maintain cylinder size. The cylinders are partially open at the top, FIG. 3, and have the aforementioned open slit 36 offering no resistance to airborne disease or contact with disease carrying patrons contaminating the entire stack of cup closures. The inside of the one piece, slit, cylinders is difficult to wash and rinse requiring a special long handled cylindrical brush that is not readily available. The slit provides access to any number of closures in the stack promoting the dispensing of more than one cup closure at a time. Users often leave the additional closures laying in the area of the dispenser. Well meaning patrons or restaurant employees are likely to replace these potentially disease carrying closures into the stack which is easily done. Steele is also limited to use in a location against a full wall because it has a very narrow base 46. Wall mounting necessitates either dismounting of the dispenser from the wall or cleaning in situ.

The patent to Garske (U.S. Pat. No. 5,944,220) discloses a covered dispenser aimed at dispensing cup closures in a sanitized manner. Notable improvements over the disclosure of Steele are an individual cap on the top of the cylinders and an open slit in the closure containing cylinder for access of the edge of the caps for dispensing. Garske however, requires a modification to the cup closure with a hole in the center, the slit in the cup closure containing cylinder remains long enough to promote contamination due to a sneeze or cough in the ambient air. The opaque, one piece tube construction also does little to promote thorough cleaning nor can the restaurant employees easily monitor the inventory of cup closures until all but a few remain. The chute covers become detached from the dispenser during the chute refilling process inviting the user to lay them on adjacent contaminated surfaces.

### SUMMARY OF THE PRESENT INVENTION

The present invention offers a unique combination of user protection features that shield cup closures from air borne and human contact contamination and facilitate ease of cleaning while maintaining the convenience and ease of maintaining a cup closure inventory of known devices. Additional features that reduce use of counter space while providing a handy place to dispense packaged condiments as well as improving restaurant appearance provides additional motivation for restaurant owners to replace serviceable equipment with new equipment for the promotion of public health.

The unique combination of features of the present invention is highlighted by the two piece construction of the clear plastic cylinders that contain the cup closures. The cross section of the cylinders facilitates low cost manufacture by extrusion or vacuum forming without the problem of spring back experienced when forming open slit tubing out of metal of other cup closures dispensing devices. The two halves of the cylinders can be easily disassembled and washed in an open sink without special cleaning implements. The clear plastic material of the cylinder walls allows for keeping track of the inventory of cup closures as well as providing visibility of the decorative insert adjacent to the cylinders. The top of the cylinders and stack of cup closures is protected by a common hinged cover and the small indentation for access to the bottom closure exposes a minimal area to the ambient air. The base of the dispenser also doubles as a tray for packaged condiments.

### BRIEF DESCRIPTION OF THE SEVERAL VIEWS OF THE DRAWING(S)

FIG. 1: Is a top view of the preferred embodiment of the present invention.

FIG. 2: Is a side view of the preferred embodiment of the present invention.

FIG. 3: Is a front view of the preferred embodiment of the present invention.

FIG. 4: Is a cross sectional view of the preferred embodiment of the present invention through “A-A” of FIG. 2.

### DETAILED DESCRIPTION OF THE PREFERRED EMBODIMENTS

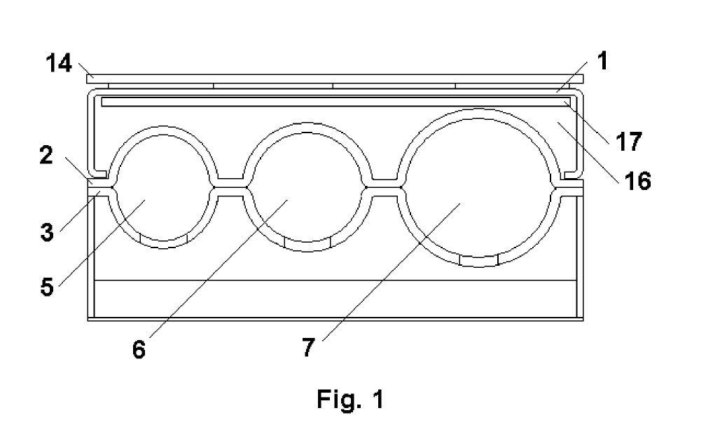

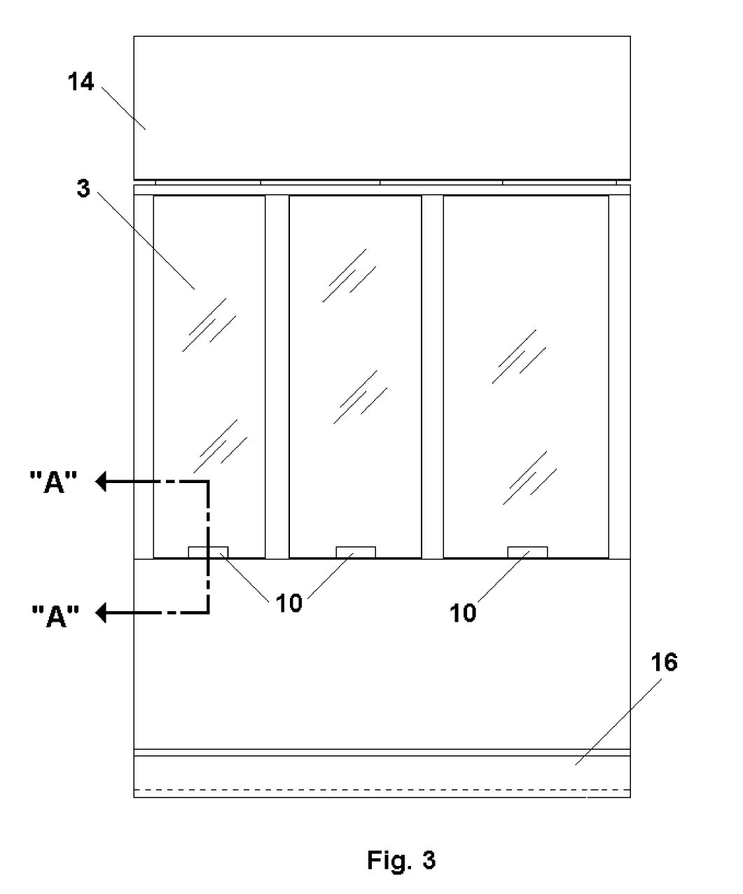

The preferred embodiment of the present invention is shown in FIGS. 1 to 3. The base 1 of the present invention is adapted to rest on a horizontal surface (not shown). It is believed adapting the instant invention for mounting on a vertical surface, floor or hanging under a shelf or changing the number of chutes is within the spirit of the present invention. Two sheets of wholly or partially clear or translucent material 2 and 3 are formed so that the space there between forms cylindrical chutes 5, 6 and 7. The uninterrupted walls of the chutes protect the cup closures 18 from contamination by contact with the ambient air.

Visibility through the cylindrical chutes allow the proprietor to take inventory of the closures without physical intervention with the apparatus. The visibility through both walls of the cylinders 2 and 3 also makes decorative panel 17 visible from the front of the dispenser.

As shown, cylindrical chute 5 is the smallest cylindrical chute, 6 and 7 are sized for the larger cup closures. However, any arrangement of cylindrical chutes to accommodate same or differing sizes and same or different shapes or thicknesses is considered to be within the spirit of the present invention.

A shelf 11 extends across some portion of the bottom of all of the cylindrical chutes 5, 6 and 7 supports the stack of cup closures.

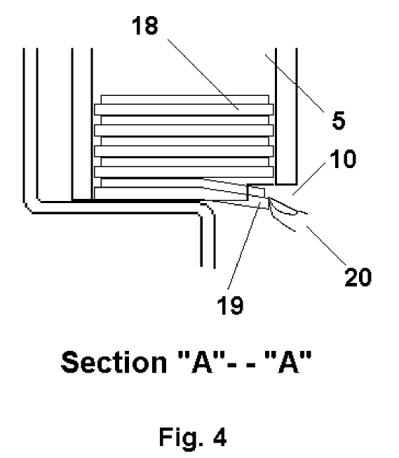

FIG. 4 shows the process of removing a cup closure from a stack of cup closures. Opening 10 in the face of cylindrical chutes 5, 6 and 7 allows the user to deflect the front edge of the bottom cup closure 19 downward with finger 20, gripping the cup closure 19 with a second finger (un-shown) and subsequently sliding the bottom cup closure 19 out of chute 5, 6 or 7.

Cover 14 is also provided to keep air borne contamination from contacting the cup closures. Cover 14 is pivoted by hinge 15. Devices that lock the cover, bias the cover in one or more positions or provide separate protection for one or more of the cylindrical chutes are also considered to be within the spirit of the present invention.

An important feature of the present invention is the construction of the cylindrical chutes 5, 6 and 7 in two parts fastened by any of a number of fastener types so that the front sheet 3 may be separated from back sheet 2 for thorough cleaning.

Lastly, it is also considered to be within the spirit of the present invention to construct a dispenser for items of any shape or size for example but not limited to coasters, napkins, sanitary disposables, condiment packages, booklets, envelopes, medical disposables or wipes.

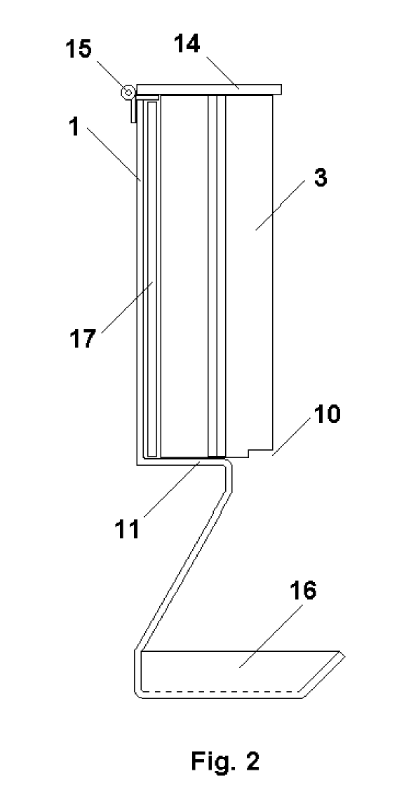

A second embodiment of the present invention would include a spring hinged door (un-shown) extending from shelf 11 of FIG. 2 and ending below slit 10 to further protect the bottom closure in the stack. The second embodiment would also provide a cover for the container 16 that extends from the rear of the container 16 and opens at the front edge of container 16.

Although the terms and definitions used in the specification are intended to be read into the claims they are hot intended to limit the meets and bounds of the claims presented here below in any manner whatsoever.

I claim:

1. A device for dispensing a stackable item from a stack of stackable items, comprising:
a stand for maintaining one or more stacks of stackable items in an essentially upright position;
one or more chutes each chute having a side wall of essentially cylindrical cross section for protecting the one or more stacks of stackable items from ambient air;
one or more shelves partially covering the bottom opening of the one or more chutes for supporting the one or more stacks of stackable items;
wherein the one or more stacks of stackable items are pressed against the at least one shelf under the force of gravity;
at least one moveable cover allowing access to the chutes for refilling the stacks of items;
an opening in the sidewall at the bottom of each chute allowing a user access to at least the edge of the bottom item in the stack;
wherein the chutes may be of any single size or shape or any combination of sizes and/or shapes.

2. The device of claim 1, wherein:
the side wall of each of the one or more chutes comprises at least two pieces.

3. The device of claim 2, wherein:
the at least two of the at least two pieces can be separately removed from the base for cleaning an inside of the chutes.

4. The device of claim 3, wherein:
wherein the one or more pieces is transparent in whole or in part for taking an inventory of the stackable items in the one or more chutes.

5. The device of claim 1, wherein:
wherein the vertical dimension of the opening in the side wall is essentially the same as a height of one cup closure.

6. The device of claim 1, further comprising:
a hinge for preventing the at least one moveable cover from contacting contaminated surfaces while the moveable cover is open.

7. The device of claim 1, further comprising:
A compartment adjacent to the chutes for containing a decorative panel.

8. The device of claim 7, further comprising:
a decorative panel for viewing through the transparent or partially transparent walls of the one or more chutes.

9. The device of claim 1, wherein:
the bottom portion of the base is formed into a container.

10. The device of claim 9, wherein:
the container is for dispensing packaged condiments.

11. The device of claim 1, wherein:
at least one of the stacks of stackable items is a stack of disposable cup closures.

12. A device for dispensing a stackable item from a stack of stackable items, comprising:
a stand for maintaining one or more stacks of stackable items in an essentially upright position;
one or more chutes each chute having a side wall of essentially cylindrical cross section for protecting the one or more stacks of stackable items from ambient air;
one or more shelves partially covering the bottom opening of the one or more chutes for supporting the one or more stacks of stackable items;
wherein the one or more stacks of stackable items are pressed against the at least one shelf under the force of gravity;
at least one moveable cover allowing access to the chutes for refilling the stacks of items;
an opening in the sidewall at the bottom of each chute allowing a user access to at least the edge of the bottom item in the stack;
wherein the chutes may be of any single size or shape or any combination of sizes and/or shapes;
the side wall of each of the one or more chutes comprises at least two pieces;
the at least two of the at least two pieces can be separately removed from the base for cleaning the inside of the chutes;
wherein the one or more pieces is transparent in whole or in part for viewing the inventory of stackable items in the one or more chutes;
wherein the vertical dimension of the opening in the side wall is essentially the height of one cup closure;
a hinge for preventing the at least one moveable cover from contacting contaminated surfaces while the moveable cover is open;
A compartment behind the chutes for containing a decorative panel;
a decorative panel for viewing through the transparent or partially transparent walls of the one or more chutes;
at least one moveable door for covering at least the bottom of at least one stack of items;
the bottom portion of the base is formed into a container;
the container is for dispensing packaged condiments;
the container is covered.

13. A method of cleaning and refilling of a device for dispensing a stackable item from a stack of stackable items, comprising the steps taken in any order:
opening a cover from the top of one or more chutes;
removing any cup closures from the chutes;
removing two or more chute sidewall parts from a base;
cleaning and or sanitizing all surfaces that contact the cup closures;
reassembling the base and the sidewall parts of the one or more chutes,
refilling the one or more chutes with cup closures;
closing the cover on the top of the one or more chutes.

14. The method of claim 13, further comprising the steps taken in any order:
sliding one or more fingers along a top of the slot at the bottom of a chute,
continuing to slide the one or more fingers directly between a top of the bottom item and a bottom of a second item from the bottom in the stack of items;
placing another finger under the bottom item in the stack;
gripping the bottom item in the stack of items between the two fingers;
pulling the bottom item of the stack of items from the bottom of the stack.
